(19) United States
(12) Patent Application Publication
(10) Pub. No.: US 2019/0226918 A1
(43) Pub. Date: Jul. 25, 2019

(54) Contact Temperature Sensor

(71) Applicant: Thomas Hand, Berlin (DE)

(72) Inventor: Thomas Hand, Berlin (DE)

(73) Assignees: TDK Electronics AG, München (DE); TDK Electronics AG, München (DE)

(21) Appl. No.: 16/341,876

(22) PCT Filed: Sep. 13, 2017
(86) PCT No.: PCT/EP2017/073037

§ 371 Date: Apr. 12, 2019

(30) Foreign Application Priority Data
Oct. 12, 2016 (DE) 102016119430.1

(51) Int. Cl. G01K 1/14; G01K 1/16; G01K 7/22; G01K 13/02

(52) U.S. Cl. CPC G01K 1/143; G01K 1/16; G01K 2013/026; G01K 13/02; G01K 7/22

(57) ABSTRACT

A contact temperature sensor is disclosed. In an embodiment a contact temperature sensor has a contact body including a bottom wall configured to bring the contact temperature sensor in contact with a test piece, a heat-conducting metal sheet arranged on a side of the bottom wall facing towards the test piece, wherein the heat-conducting metal sheet is configured to conform to a surface shape of the test piece when the contact body is brought in contact with the test piece, a temperature sensor element and a heat-conducting pad arranged to thermally couple the temperature sensor element and the heat-conducting metal sheet, wherein the heat-conducting pad is in each case directly thermally coupled to the heat-conducting metal sheet and the temperature sensor element.

This patent application is a national phase filing under section 371 of PCT/EP2017/073037, filed Sep. 13, 2017, which claims the priority of German patent application 102016119430.1, filed Oct. 12, 2016, each of which is incorporated herein by reference in its entirety.

### TECHNICAL FIELD

The invention relates to a contact temperature sensor with a temperature sensor element for measuring a temperature.

### BACKGROUND

The term “contact temperature sensor” is used to refer to electric temperature sensors in which the heat transfer between test object and sensor occurs only by way of a specific contact surface. Contact temperature sensors are often used for the indirect temperature measurement of liquids in pipes. If the contact temperature sensors are brought into contact with pipes having poor heat conduction, the response time of the sensor elements of the contact temperature sensors increases and predefined response time requirements for specific applications, e.g., in the white goods sector, cannot be met.

### SUMMARY OF THE INVENTION

Embodiments provide a contact temperature sensor that allows sufficiently good heat transport from a test piece to a sensor element of the contact temperature sensor.

Embodiments provide a contact temperature sensor having a contact body. The contact body has a bottom wall by which the contact temperature sensor is brought into contact with a test piece. Furthermore, the contact body comprises a heat-conducting metal sheet or a heat-conducting foil, which is arranged on a side of the bottom wall facing towards the test piece and is configured such that it conforms to a surface shape of the test piece when the contact body is brought into contact with the test object. In addition, the contact body has a temperature sensor element and a heat-conducting pad. The heat-conducting pad is arranged and configured to thermally couple the temperature sensor element and the heat-conducting metal sheet or heat-conducting foil, the heat-conducting pad being in each case directly thermally coupled to the heat-conducting metal sheet and the temperature sensor element.

The test piece comprises, e.g., a pipe. Inside the pipe a fluid, e.g., a coolant, can flow or can be at rest.

The heat-conducting metal sheet is in particular configured to conform to various curvatures of tubular test pieces. This has the advantage that the contact body can be used for test pieces with various pipe diameters.

The heat-conducting metal sheet advantageously enables a planar heat transfer from the surface of the test piece to the heat-conducting pad, enabling rapid heat transport to take place from the test piece to the heat-conducting pad. Preferably the area and/or thickness of the heat-conducting metal sheet is/are selected such that the heat capacity of the heat-conducting metal sheet does not outweigh the advantages of rapid heat transport.

The heat-conducting pad may have a cushion-like configuration and comprises soft, formable, thermally conductive material. Compared with a heat-conducting paste, the material of the heat-conducting pad does not set hard. The heat-conducting pad has, e.g., a resilient configuration. Depending on respective dimensions relating to the shape and thickness of the heat-conducting pad and material properties of the heat-conducting pad, required or desired response times of the contact temperature sensor can be achieved.

Thus, both the heat-conducting pad and the heat-conducting metal sheet are configured such that their shape conforms to the surface shape of the test piece. In particular, this conforming can take place repeatedly. Since the heat-conducting pad remains flexible even in the assembled state of the contact temperature sensor, the heat-conducting metal sheet and the heat-conducting pad together can also conform to a change, in particular a repeated change, in the surface shape of the test piece, e.g., as a result of thermal expansion or contraction of the test piece.

As a result of the improved heat transfer from the surface of the test piece to the heat sensor element, more rapid response times of the contact temperature sensor can be achieved.

In an advantageous embodiment, the temperature sensor element is inserted in the heat-conducting pad. Preferably, the temperature sensor element is only inserted in the heat-conducting pad, i.e., it is not connected to the heat-conducting pad by means of a connection made by a substance-to-substance joining method, such as, e.g., an adhesive bond. This allows the contact body to conform flexibly to the surface shape of the test piece since, as well as the shape of the heat-conducting metal sheet and of the heat pad conforming, a position and/or arrangement of the heat sensor element in the heat-conducting pad can also conform, e.g., when the contact body is pressed on to the test piece.

In a further advantageous embodiment, the contact body has a cavity with an opening. The opening is arranged in the bottom wall and is at least partly covered by the heat-conducting metal sheet. The temperature sensor element and the heat-conducting pad are arranged at least partly in the cavity and the temperature sensor element is in part surrounded directly by the heat-conducting pad and otherwise surrounded by air in the cavity. The air acts as a thermal insulator, so that thermal energy is only minimally transported away from the temperature sensor element.

Depending on the volume of the remaining space in the cavity, which is filled with air, different response times of the contact temperature sensor can be achieved. The volume of the remaining space in the cavity, which is filled with air, can also be referred to as the air gap dimension. The air gap dimension can be varied in each case according to the required or desired response times.

In a further advantageous embodiment, the temperature sensor element comprises a thermistor. The thermistor can also be referred to as an NTC resistor (Negative Temperature Coefficient resistor). The thermistor comprises a resistor with a negative temperature coefficient. The thermistor advantageously enables a temperature or a temperature change on the surface of the test object to be measured very simply and cost-effectively.

In a further advantageous embodiment, the temperature sensor element comprises a glass-coated or an epoxy-resin-coated thermistor. The glass coating of the thermistor is preferably configured such that the thermistor is resistant to moisture and/or other environmental influences and therefore the temperature sensor element exhibits increased reliability. In particular, the glass coating prevents moisture from penetrating into the thermistor.

In a further advantageous embodiment, the heat-conducting metal sheet is pre-bent, so that it has a curvature with a predefined radius and has spring properties. The pre-rounded resilient heat-conducting metal sheet has the advantage that it can closely and exactly fit against pipes with different pipe diameters. The predefined curvature is preferably greater than a curvature of the test pieces.

In a further advantageous embodiment, the contact temperature sensor comprises a retaining clip for the thermistor, which is arranged in the cavity of the contact body and which is arranged and configured to hold the temperature sensor element in a predefined position.

In a further advantageous embodiment, the retaining clip has a resilient configuration. This enables the thermistor, in particular a part of the thermistor that comprises the resistor material and/or the resistor structures of the thermistor, to be held in an optimum position from a metrology point of view. The part of the thermistor that comprises the resistor material and/or the resistor structures of the thermistor can also be referred to as the thermistor head.

### BRIEF DESCRIPTION OF THE DRAWINGS

Exemplary embodiments of the invention are explained below with reference to the schematic drawings.

The figures show the following:

FIG. 1 shows a sectional view of an exemplary embodiment of a contact temperature sensor; and

FIG. 2 shows a first sectional view of an exemplary embodiment of a contact body of the contact temperature sensor.

Elements with the same construction or function are provided with the same reference numbers across all the figures.

### DETAILED DESCRIPTION OF ILLUSTRATIVE EMBODIMENTS

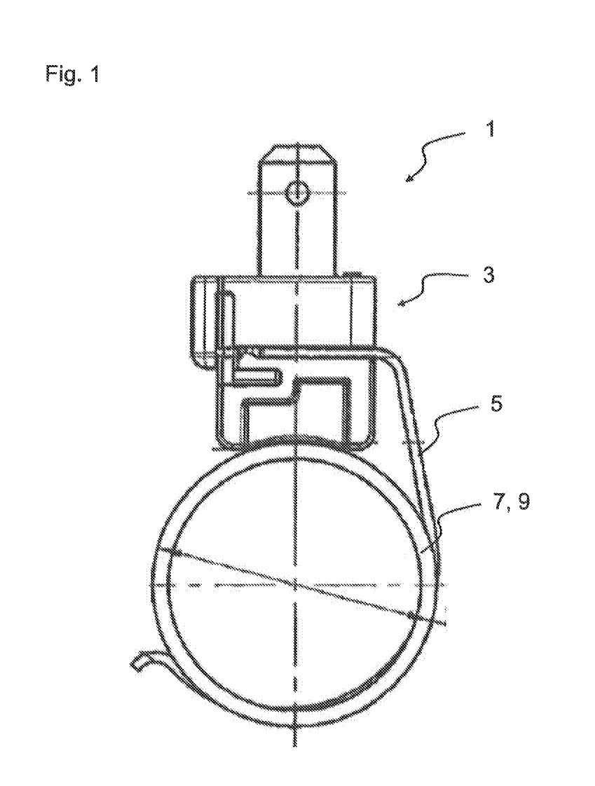

FIG. 1 shows a sectional view of an exemplary embodiment of a contact temperature sensor 1. The contact temperature sensor 1 comprises a contact body 3 and, for example, a tension clamp 5. One end of the tension clamp 5 is mechanically coupled to the contact body 3, for example. The tension clamp 5 is arranged and configured to press the contact body 3 against a test piece 7 and to hold the contact body 3 in place against the test piece 7. Alternatively, the contact temperature sensor 1 can have a tension strap, both ends of which are attached to the contact body 3. Preferably, the tension strap is adjustable in length.

In the exemplary embodiment shown, the contact temperature sensor 1 is mounted on a test piece 7 in the form of a pipe 9. Inside the pipe 9 a fluid, e.g., a coolant, which is not shown here, can flow or can be at rest. The contact temperature sensor can be used to determine the temperature of the fluid. The contact temperature sensor 1 comprises a temperature sensor element 30, which is in thermal contact with the pipe 9. The contact body 3 has a connector housing 13. Inside the connector housing 13 a contact pin 15 is arranged, which is connected to the temperature sensor element 30 via conductive connections.

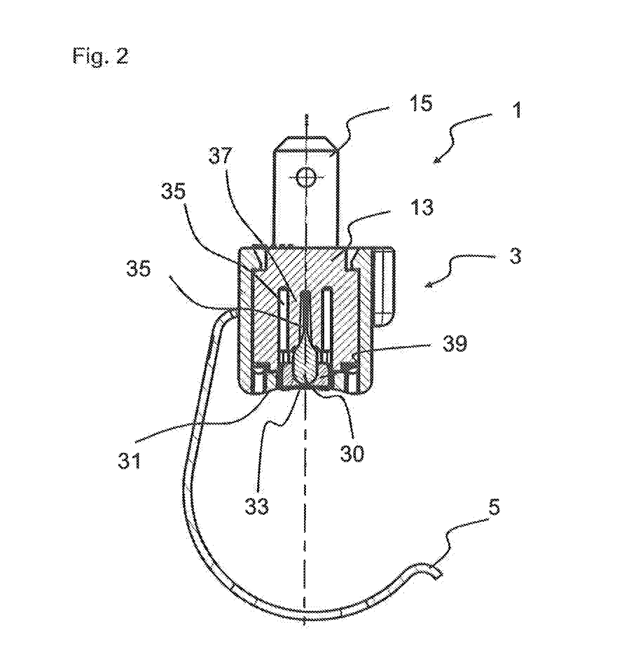

FIG. 2 shows a first sectional view of an exemplary embodiment of the contact body 3 in detail. The contact body 3 has a bottom wall 31 by which the contact temperature sensor 1 is brought into contact with the test piece 7. On a side of the bottom wall 31 facing towards the test piece 7 a heat-conducting metal sheet 33 is arranged. Preferably, the heat-conducting metal sheet is arranged on the bottom wall such that only the heat-conducting metal sheet 33 has direct contact with the test piece 7 but the bottom wall 31 does not. Alternatively, a heat-conducting foil can be arranged on the side of the bottom wall 31 facing towards the test piece 7. The heat-conducting metal sheet 33 preferably comprises or consists of copper. For example, the heat-conducting metal sheet can have a coating that comprises copper. The heat-conducting metal sheet can have a nickel coating, for example. The heat-conducting metal sheet 33 is configured to be flexible, so that at least part of it can fit closely against a surface shape of the test piece 7. For example, the heat-conducting metal sheet 33 is configured and arranged such that it fits closely against the curvature of tubular test pieces 7 with various pipe diameters. To this end, the heat-conducting metal sheet 33 can be pre-bent, in which case the heat-conducting metal sheet 33 has a curvature with a predefined radius. A sheet thickness of the heat-conducting metal sheet 33 is preferably selected such that the heat-conducting metal sheet 33 has spring properties.

The contact body 3 has a cavity 35 with an opening in which a heat-conducting pad 39 and the temperature sensor element 30 are at least partly arranged. The opening is arranged in the bottom wall 31 of the contact body 3 and is covered or sealed at least in part by the heat-conducting metal sheet 33.

Preferably, the temperature sensor element 30 is inserted in the heat-conducting pad 39. To hold the temperature sensor element 30 in a desired measuring position, for example, a retaining clip or multiple retaining clips are arranged in the contact body 3. The retaining clips have, for example, a beak-like configuration and consist of a plastic or partly consist of plastic. Depending on the wall thickness of the respective retaining clip, in particular of the “beak”, the respective retaining clip can also have a spring action.

The temperature sensor element 30 is preferably surrounded by air outside the insertion region in which it is in direct contact with the heat-conducting pad 39. The cavity 35 thus forms an air chamber for the temperature sensor element 30. The air acts as a thermal insulator, so that thermal energy is only minimally transported away from the temperature sensor element 30.

The heat-conducting pad 39 has in particular a cushion-like configuration and comprises soft, formable, thermally conductive material. The heat-conducting pad 39 has, e.g., a resilient configuration.

The temperature sensor element 30, in an assembled state in which the contact temperature sensor 1 is in contact with the test object 7, is thermally coupled to the test piece 7 by way of the heat-conducting pad 39 and the heat-conducting metal sheet 33.

The heat-conducting pad 39 is arranged partly in the opening of the bottom wall 31 of the contact body 3 and thermally couples the heat-conducting metal sheet 33 to the temperature sensor element 30.

Preferably, a side of the heat-conducting metal sheet 33 facing away from the test piece 7 is at least partly in direct contact with the heat-conducting pad 39 and the heat-conducting pad 39 is thus preferably directly thermally coupled to the heat-conducting metal sheet 33. “Directly thermally coupled” means that no layer affecting or noticeably affecting the heat flow, for example, an adhesive layer and/or heat-conducting paste, is arranged between the heat-conducting pad 39 and the heat-conducting metal sheet 33.

The temperature sensor element 30 preferably comprises a thermistor, also known as an NTC resistor (NTC—Negative Temperature Coefficient). The temperature sensor element 30 comprises, e.g., a glass-coated thermistor. Alternatively, the temperature sensor element 30 can comprise an epoxy-resin-coated thermistor.

1-8. (canceled)

9. A contact temperature sensor comprising:
a contact body comprising:
a bottom wall configured to bring the contact temperature sensor in contact with a test piece;
a heat-conducting metal sheet arranged on a side of the bottom wall facing towards the test piece, wherein the heat-conducting metal sheet is configured to conform to a surface shape of the test piece when the contact body is brought in contact with the test piece;
a temperature sensor element; and
a heat-conducting pad arranged to thermally couple the temperature sensor element and the heat-conducting metal sheet, wherein the heat-conducting pad is in each case directly thermally coupled to the heat-conducting metal sheet and the temperature sensor element.

10. The contact temperature sensor according to claim 9, wherein the temperature sensor element is insertable in the heat-conducting pad.

11. The contact temperature sensor according to claim 9,
wherein the contact body comprises a cavity with an opening,
wherein the opening is arranged in the bottom wall and is at least partly covered by the heat-conducting metal sheet,
wherein the temperature sensor element and the heat-conducting pad are arranged at least partly in the cavity, and
wherein the temperature sensor element is in part surrounded directly by the heat-conducting pad and is otherwise surrounded by air in the cavity.

12. The contact temperature sensor according to claim 9, wherein the temperature sensor element comprises a thermistor.

13. The contact temperature sensor according to claim 9, wherein the temperature sensor element comprises a glass-coated or an epoxy-resin-coated thermistor.

14. The contact temperature sensor according to claim 9, wherein the heat-conducting metal sheet is pre-bent such that it has a curvature with a predefined radius and has spring properties.

15. The contact temperature sensor according to claim 9, further comprising a retaining clip for the temperature sensor element arranged in a cavity of the contact body, wherein the retaining clip is configured to hold the temperature sensor element in a predefined position.

16. The contact temperature sensor according to claim 15, wherein the retaining clip has a resilient configuration.

17. A contact temperature sensor comprising:
a contact body comprising:
a bottom wall configured to bring the contact temperature sensor in contact with a test piece;
a heat-conducting metal sheet arranged on a side of the bottom wall facing towards the test piece, wherein the heat-conducting metal sheet is configured to conform to a surface shape of the test piece when the contact body is brought into contact with the test piece,
a temperature sensor element; and
a heat-conducting pad arranged to thermally couple the temperature sensor element and the heat-conducting metal sheet, wherein the heat-conducting pad is in each case directly thermally coupled to the heat-conducting metal sheet and the temperature sensor element, and wherein the temperature sensor element is insertable in the heat-conducting pad.

18. The contact temperature sensor according to claim 17,
wherein the contact body comprises a cavity with an opening,
wherein the opening is arranged in the bottom wall and is at least partly covered by the heat-conducting metal sheet,
wherein the temperature sensor element and the heat-conducting pad are arranged at least partly in the cavity, and
wherein the temperature sensor element is in part surrounded directly by the heat-conducting pad and is otherwise surrounded by air in the cavity.

19. The contact temperature sensor according to claim 17, wherein the temperature sensor element comprises a thermistor.

20. The contact temperature sensor according to claim 17, wherein the temperature sensor element comprises a glass-coated or an epoxy-resin-coated thermistor.

21. The contact temperature sensor according to claim 17, wherein the heat-conducting metal sheet is pre-bent such that it has a curvature with a predefined radius and has spring properties.

22. The contact temperature sensor according to claim 17, further comprising a retaining clip for the temperature sensor element arranged in a cavity of the contact body, wherein the retaining clip is configured to hold the temperature sensor element in a predefined position.

23. The contact temperature sensor according to claim 22, wherein the retaining clip has a resilient configuration.

24. A contact temperature sensor comprising:
a contact body comprising:
a bottom wall configured to bring the contact temperature sensor in contact with a test piece;
a heat-conducting metal sheet arranged on a side of the bottom wall facing towards the test piece, the heat-conducting metal sheet is configured to conform to a surface shape of the test piece when the contact body is brought into contact with the test piece;
a temperature sensor element; and
a heat-conducting pad arranged to thermally couple the temperature sensor element and the heat-conducting metal sheet, wherein the heat-conducting pad is in each case directly thermally coupled to the heat-conducting metal sheet and the temperature sensor element, and wherein the heat-conducting metal sheet is pre-bent such that it has a curvature with a predefined radius and has spring properties.

25. The contact temperature sensor according to claim 24,
wherein the contact body comprises a cavity with an opening,
wherein the opening is arranged in the bottom wall and is at least partly covered by the heat-conducting metal sheet,
wherein the temperature sensor element and the heat-conducting pad are arranged at least partly in the cavity, and
wherein the temperature sensor element is in part surrounded directly by the heat-conducting pad and is otherwise surrounded by air in the cavity .

26. The contact temperature sensor according to claim 24, wherein the temperature sensor element comprises a glass-coated or an epoxy-resin-coated thermistor.

27. The contact temperature sensor according to claim 24, wherein the temperature sensor element is inserted in the heat-conducting pad.

28. The contact temperature sensor according to claim 24, further comprising a retaining clip for the temperature sensor element, wherein the retaining clip is arranged in a cavity of the contact body and is configured to hold the temperature sensor element in a predefined position.
